(19) United States
(12) Patent Application Publication
(10) Pub. No.: US 2024/0426354 A1
(43) Pub. Date: Dec. 26, 2024

(54) VEHICLE DRUM BRAKE

(71) Applicant: ZF CV Systems Europe BV, Brussels (BE)

(72) Inventor: Paul Henning, Schwetzingen (DE)

(21) Appl. No.: 18/750,022

(22) Filed: Jun. 21, 2024

(30) Foreign Application Priority Data
Jun. 22, 2023 (DE) 10 2023 116 370.1

(51) Int. Cl. F16D 51/10; F16D 51/00; F16D 65/22; F16D 65/50; F16D 121/02; F16D 121/24; F16D 125/66

(52) U.S. Cl. CPC F16D 51/10; F16D 65/22; F16D 65/50; F16D 2051/003; F16D 2121/02; F16D 2121/24; F16D 2125/66

(57) ABSTRACT

A vehicle drum brake includes a drum (3) having an inner friction surface (21) formed circumferentially, a brake carrier (5) that can move in rotation relative to the drum (3) about a drum axis (X), and a brake lining assembly (7) arranged on the brake carrier (5). The brake lining assembly (7) has a plurality of radially movable lining carriers (11), on each of which a brake lining segment (9) is provided, facing the friction surface (21). The drum brake (1) has an actuating ring (13) displaceable along the drum axis (X) and rotatable about the drum axis (X), and a displacement surface arrangement (30), which is operatively connected to the lining carriers (11). The displacement surface arrangement (30) is shaped such that both the axial displacement and the rotary movement of the actuating ring (13) bring about a respective synchronous radial movement of all the lining carriers (11).

### FIELD

The present disclosure relates to a vehicle drum brake, in particular for commercial vehicles, with a drum having an inner friction surface formed circumferentially, a brake carrier, which is arranged within the drum in such a way that it can move in rotation relative to the drum about a drum axis, and a brake lining assembly, which is arranged on the brake carrier, wherein the brake lining assembly has a plurality of radially movable lining carriers, on each of which a brake lining segment is provided, facing the friction surface.

### BACKGROUND

Drum brakes of the type designated at the outset are widely known. They are generally encapsulated to enable them to be used in applications where low-emission operation is desired, i.e. operation in which the quantities of dust or other abraded material from braking that enters the environment should be as small as possible.

Drum brakes are widespread in the commercial vehicle sector, and also in isolated cases in the passenger vehicle sector, e.g. on the rear axle of private cars or in vehicles with electric drives, in which there is less need for the use of conventional friction brakes in operation owing to the possibility of regenerative braking by way of the electric machines.

The general principle of operation of drum brakes is that the friction lining assembly is pressed against the drum by way of an actuator mechanism. In the prior art, there are known drum brakes with one or two brake linings in which a linear actuator or a crescent-shaped cam head is moved against the brake lining assembly and presses the brake lining assembly against the drum. Owing to the principle involved and depending on the direction of rotation of the braked wheels, self-energizing effects arise during this process, and these may be unwanted when controlling the braking behavior. In the case of prolonged deceleration processes, temperature-induced and speed-dependent fading is furthermore a technical challenge which restricts the areas of application of drum brakes.

Moreover, nonuniform wear may often be observed in conventional drum brakes owing to their geometrical construction and the force introduction points.

It has therefore been proposed, in the case of a vehicle drum brake of the type stated at the outset, to equip the brake lining assembly with a plurality of radially movable lining carriers, on each of which a brake lining segment is provided, facing the friction surface, wherein the lining carriers are each operatively connected directly to a common cam ring in such a way that a rotary movement of the cam ring in a first direction of rotation brings about a synchronous application movement of all the lining carriers, and a rotary movement of the cam ring in an opposite, second, direction of rotation brings about a synchronous release movement of all the lining carriers. By way of substantially radial, centric introduction of force, it is possible to reduce self-energization effects in an effective manner.

The above-described drive solution for the segmented drum brake has proven its ability to function in practice. However, in view of the fact that commercial vehicles are often fitted with a pneumatic compressed air supply and have a brake control system which is configured for pneumatic brake systems, there is a desire to improve a vehicle brake of the type designated at the outset in such a way that other types of drive, such as a pneumatic drive or hybrid types of drive, remain possible. The present disclosure was furthermore based on the object of further developing a drum axle of the type designated at the outset in such a way that improved operation of the drum brake is made possible.

### SUMMARY

The present disclosure achieves the object on which it is based, in the case of a vehicle drum brake of the type designated at the outset, in that said drum brake is designed in accordance with aspects of the disclosure herein. In particular, the present disclosure provides that the drum brake has an actuating ring, which is arranged in the drum in such a way as to be displaceable along the drum axis and rotatable about the drum axis, and a displacement surface arrangement, which is operatively connected to the lining carriers, wherein the displacement surface arrangement is shaped in such a way that both the axial displacement and the rotary movement of the actuating ring bring about a respective synchronous radial movement of all the lining carriers. The movement of the actuating ring is thereby extended to several degrees of freedom in comparison with the prior art. Where, in the prior art, only a rotary movement of a rotary ring was envisaged, the kinematic concept of the present disclosure provides the combination of a rotary movement, on the one hand, and axial displaceability, on the other hand. This makes it possible to actuate the two degrees of freedom of the actuating ring separately, improving flexibility in the activation of the brake. The actuating ring is preferably a one-piece body. The displacement surface arrangement is preferably formed on the actuating ring or formed integrally on the latter, ensuring that every movement of the actuating ring is simultaneously an identical movement of the displacement surface arrangement. As a result, the required variety of parts in the drum brake also remains manageable.

The present disclosure is developed further in an advantageous way by the fact that, to execute the axial movement, the actuating ring is coupled to a first actuator and, for carrying out the rotary movement, is coupled to a second actuator, wherein the first and second actuators are kinematically decoupled from one another. Here too, the present disclosure makes use of the available mobility of the actuating ring in two degrees of freedom. The kinematic decoupling of the two actuators makes it possible to perform a radial movement of the lining carriers with the two actuators independently of one another. It is then advantageous if high forces are to be transmitted with one of the two forms of movement, e.g. the axial movement, for instance for the service braking function and the parking brake function of the drum brake, while only low forces have to be transmitted and/or relatively short adjustment travels have to be implemented by way of the second actuator, e.g. for wear compensation of the release clearance between the brake linings and the drum.

Consequently, the decoupling of the actuators enables separate activation of the actuating ring and increases flexibility in the activation of the drum brake.

In another preferred embodiment, the actuating ring is displaceable between a first, retracted, axial position and a second, extended, axial position, this being converted in a radial direction into a first stroke length of the brake lining assembly, and is rotatable between a first rotational position and a second rotational position, this being converted in a radial direction into a second stroke length of the brake lining assembly. According to the present disclosure, the stroke length should be understood to mean the maximum radial adjustment travel of the brake lining assembly.

The two stroke lengths may be designed to be identical. In one preferred embodiment, however, the first stroke length is different from the second stroke length, wherein the larger of the two stroke lengths defines a range of movement for an application and release movement of the main braking function of the drum brake, and the smaller of the two stroke lengths defines a range of movement for release clearance adjustment of the drum brake. According to the present disclosure, the main braking function should be understood to mean the service braking function and/or parking brake function of the drum brake. The first stroke length is preferably larger than the second stroke length.

In another preferred embodiment, the displacement surface arrangement has a displacement surface which faces the brake lining assembly and which interacts with the brake lining assembly in such a way that a movement of the displacement surface is converted into the radial movement of the lining carriers. The interaction between the brake lining assembly and the actuating ring along the displacement surface can be implemented by way of the sliding action of component elements capable of movement relative to one another or by way of the rolling action of radially movable component elements on the displacement surface as a result of the movement of the actuating ring.

In one preferred embodiment, the displacement surface has a rising profile, i.e. an increasing perpendicular distance relative to the drum axis, from the first axial position, along the drum axis, in the direction of the second axial position, which profile defines the first stroke length. In other words, the displacement surface has a first axial end and a second axial end, wherein the second axial end has a greater radial extent, relative to the drum axis, than the first axial end, and wherein the lining carriers are arranged closer to the first axial end in the first axial position of the actuating ring than in the second axial position. When viewed in the axial direction, the displacement surface thus preferably has a wedge shape.

In another preferred embodiment, the displacement surface has a plurality of surface segments, wherein each of the lining carriers is preferably assigned a dedicated surface segment. This makes it possible to ensure that the individual lining carriers of the brake lining assembly can roll or slide on a displacement surface segment individually assigned to them. In other words, the displacement surface is preferably divided into a plurality of surface segments.

In another preferred embodiment, the surface segments of the displacement surface are at an increasing perpendicular distance, relative to the drum axis, in the circumferential direction from the first rotational position in the direction of the second rotational position, which profile defines the second stroke length.

In another preferred embodiment, the profile, i.e. the variation in the perpendicular distance, in the axial direction between the first axial position and the second axial position is linear. Consequently, the adjustment travel of the brake lining assembly is proportional to the displacement travel of the actuating ring in the axial direction, and this is advantageous for the uniformity with which the braking force develops over the adjustment travel.

In another preferred embodiment, the profile, i.e. the increase in the perpendicular distance, in the circumferential direction between the first and second rotational positions is proportional to the angle of rotation. The adjustment travel of the brake lining assembly thus varies in linear proportion to the angle of rotation between the first and second rotational positions. The external appearance of the displacement surface in the circumferential direction therefore corresponds to a convex curvature. The combination of a linear profile in the axial direction and an angularly proportional profile in the circumferential direction accordingly corresponds in external appearance to a uniaxial convex curvature.

In another preferred embodiment of the present disclosure, the first actuator is a pneumatic actuator. The use of a pneumatic actuator is advantageous particularly for the axial displacement of the actuating ring because pneumatic activation allows the transmission of high forces, and a rapid response is ensured.

In another preferred embodiment of the present disclosure, the second actuator is an electric motor actuator. The use of an electric motor actuator for the rotary movement of the actuating ring is advantageous particularly because very precise activation of the brake lining assembly is made possible by way of the electric motor actuator, and this indicates use for release clearance adjustment. Since release clearance adjustment generally takes place at times in which there is no need for a braking maneuver to be carried out by the first actuator, the second actuator does not have to transmit large forces, and this advantageously extends the life both of the actuator and of the actuating ring.

In another preferred embodiment, the second actuator is coupled to the actuating ring by way of a mechanism, as a further preference by way of a gear mechanism. By this arrangement, it is possible to transmit any speed increase or speed reduction in the driving work of the electric motor actuator that may be required, depending on the application, to the actuating ring.

In a preferred development, the number of lining carriers is within a range of six or more, preferably eight or more, particularly preferably in a range of 12 or more. The lining carriers are preferably arranged in a uniformly distributed manner over the circumference of the brake carrier.

As a further preference, the brake lining segments are each configured for full-surface contact with the drum, that is to say they have a convex curvature corresponding to the curvature of the friction surface. Along with the radial guidance of the movement of the lining carriers, the tendency for self-intensification is combated because, irrespective of the direction of rotation, the action of force on the lining carriers now depends only on the actuation travel of the actuating ring, and the resulting counter force is no longer affected by the direction of rotation of the drum. Moreover, wear is minimized because the number of friction partners and their distribution over the circumference of the drum are improved. Since a higher proportion of the friction surface of the drum is acted upon by brake linings than in the prior art, the tendency for “fading” is also reduced in comparison with the prior art.

In another preferred embodiment, the lining carriers have a piston which faces the cam portion, is arranged in a radially movable manner in the brake carrier and is configured to be moved backward and forward between an applied braking position and a released free running position by way of displacement by the cam portion as the actuating ring rotates.

The maximum stroke of the piston corresponds to the stroke of the respective cam portion and it is a simple matter in terms of design, by appropriate dimensioning of the actuating ring, to configure it in such a way that it reliably covers the region of the maximum lining thickness plus an allowance for thermal expansion. The geometry of the actuating ring and of the cam portions can be produced with high precision, thereby making it possible to ensure, in a manner that is simple in terms of design, that all the lining carriers, together with their pistons, cover the same application travel or release travel during the rotary movement of the actuating ring.

When the brake is first put into operation, the forced synchronization of the pistons and thus of the brake lining segments furthermore ensures very uniform distribution of the retardation force after only a few braking operations in the run-in process of the brake because production-related differences in lining thickness on the brake lining segments is evened out very quickly. The brake lining segments whose brake linings have a greater thickness are subjected to higher wear during the initial braking operations, but this changes as soon as they have reached a thickness which corresponds to the thicknesses of the other brake lining segments. The wear in the system thus remains uniform at all times, even in the case of prolonged usage.

### BRIEF DESCRIPTION OF THE DRAWINGS

The present disclosure is described in greater detail below by way of an exemplary embodiment with reference to the attached drawings. In the drawings:

FIG. 1 shows a schematic, three-dimensional, partially sectioned view of a drum brake according to a preferred exemplary embodiment,

FIG. 2 shows a detail view in cross section of the drum brake from FIG. 1 in a first operating state,

FIG. 3 shows a view according to FIG. 2 in another operating state, and

FIG. 4 shows a detail view of an actuating ring of the drum brake according to FIGS. 1-3.

### DETAILED DESCRIPTION

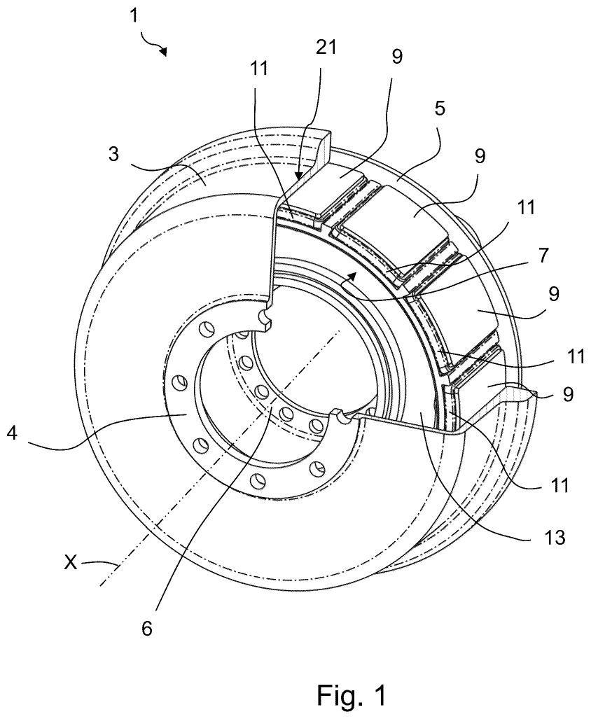

FIG. 1 shows a drum brake 1 according to a preferred exemplary embodiment of the present disclosure. The drum brake 1 is a commercial vehicle drum brake of closed construction, referred to as a zero-emission drum brake. The drum brake 1 has a drum 3, with a flange 4 for attachment to the wheel. The drum brake 1 furthermore has a brake carrier 5, which, together with the drum 3, forms a housing. The brake carrier 5 likewise has a flange 6, by way of which the brake carrier 5 can be attached to the vehicle.

A brake lining assembly 7 is arranged in the interior of the housing formed by the drum 3 and the brake carrier 5. The brake lining assembly 7 has a multiplicity of brake lining segments 9, namely a total of twelve according to one embodiment, which are pressed into a radially movable lining carrier 11, wherein the lining carrier 11 is guided in a radially movable manner on the brake carrier 5. The adjusting movement of the lining carriers 11 with the brake lining segments 9 is accomplished by way of an actuating ring 13, which can be turned in rotation about a drum axis X and displaced axially in the direction of the drum axis X.

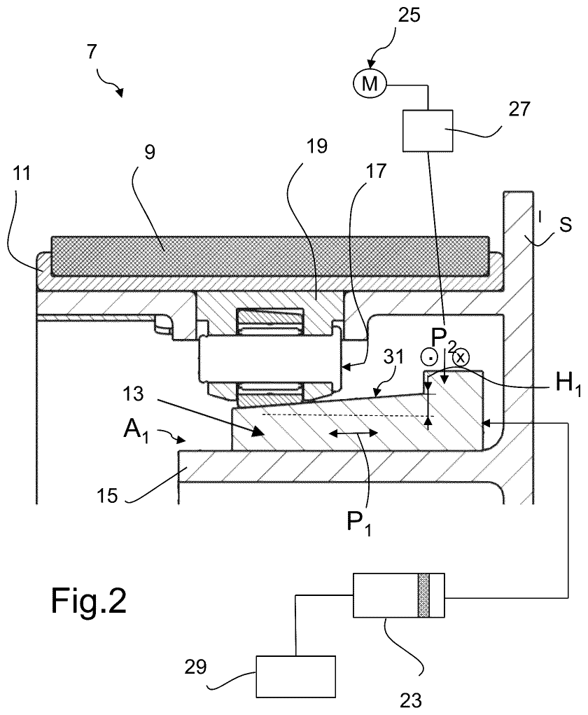

FIGS. 2-4 illustrate the action of the drum brake according to the present disclosure, in particular of the actuating ring 13 of the drum brake 1.

FIG. 2 shows the drum brake in cross section in a plane which coincides with the drum axis X. The actuating ring 13 is arranged in sliding fashion on a stub 15 of the brake carrier 5. The actuating ring 13 is in a first, retracted, axial position A₁. The brake lining assembly 7, of which one brake lining segment 9 with a lining carrier 11 is shown here by way of example, is coupled to the actuating ring 13 by way of a bearing assembly 17 and a piston 19, which can move radially in a guided manner. The actuating ring 13 has a displacement surface arrangement 30 having a displacement surface 31, which is operatively connected to the piston 19 of the brake lining assembly 7 in such a way that an axial movement of the actuating ring 13 in the direction of arrow P₁ results in a radial deflection of the piston 19 and, with the latter, of the brake lining segment 9.

The displacement surface arrangement 30 is formed integrally on the actuating ring 13, and each movement of the actuating ring is an identical movement of the actuating surface arrangement 30.

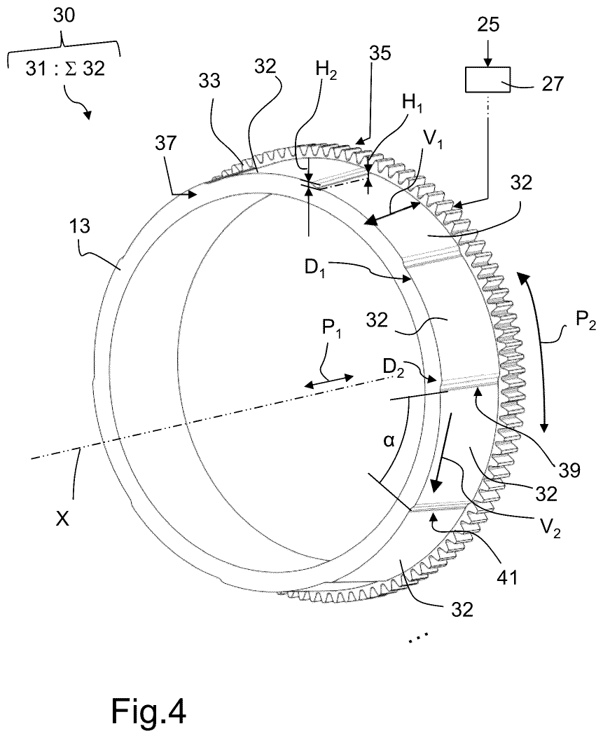

The maximum deflection which the brake lining assembly 7 can perform in the radial direction as a result of this interaction is defined by a first stroke length H₁. The actuating ring 13 is furthermore also mounted on the stub 15 in such a way as to be rotatable about the drum axis X, and can be moved in both rotational directions in the direction of arrow P₂, cf. especially FIG. 4.

To bring about the axial displacement in the direction of arrow P₁, the actuating ring 13 is operatively connected to a first actuator 23, which can be a pneumatic actuator, for example. The first actuator 23 is connected in a fluid-transmitting manner to a compressed air supply 29, preferably the compressed air supply of the brake system of a commercial vehicle (not shown).

To bring about the rotary movement in the direction of arrow P₂, the actuating ring 13 is furthermore operatively connected to a second actuator 25, which can be an electric motor actuator, for example. The second actuator 25 is preferably coupled to the actuating ring 13 by way of a mechanism 27.

The first actuator 23 and the second actuator 25 are kinematically decoupled from one another. Accordingly, activation of just one of the actuators 23, 25 brings about only the movement of the actuating ring 13 exclusively in the selected direction. In other words, activation by way of the first actuator 23 brings about exclusively the displacement movement in the direction of arrow P₁, and activation only by the second actuator 25 brings about exclusively a rotary movement in the direction of arrow P₂ about the drum axis X.

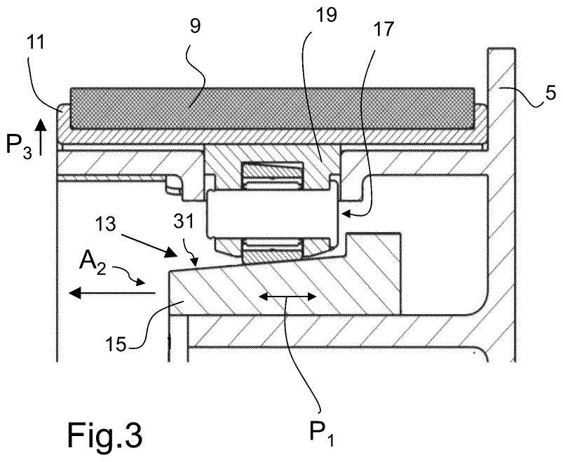

In FIG. 3, following activation by the first actuator 23, the actuating ring 13 has been moved in the direction of arrow P₁ out of the first axial position A₁ into a second, extended, axial position A₂. Owing to a rising profile V₁ of the displacement surface 31 in the direction of the drum axis X, the brake lining assembly 7 has been deflected radially owing to the movement of the piston 19 in the direction of arrow P₃. Owing to the coupling of all the brake lining segments 9 of the drum brake 1, this has taken place synchronously in the case of all the brake lining segments 9.

As a particular preference, activation by way of the first actuator 23 is used to bring about the application and release movement of the brake lining assembly 7 for the service braking and/or parking brake function.

In addition to the adjusting movement, shown in FIGS. 2 and 3, of the brake lining assembly 7, adjustment of the brake lining assembly 7 in the radial direction by way of activation of the actuating ring 13 by the second actuator 25 is furthermore also possible, this being particularly clearly apparent also from FIG. 4.

While the rising axial profile V₁, which defines the first stroke length H₁, extends between a first axial end 35 and a second axial end 37, the displacement surface 31, which is divided into a number of surface segments 32 that corresponds to the number of brake lining segments 9, has a first rotational position D₁ and a second rotational position D₂ for each of the surface segments 32, which are each offset from the respectively adjacent surface segment 32 by step-type boundaries 39, 41.

Between rotational positions D₁ and D₂, the respective surface segment 32 forms an angle α along which the surface segment 32 has a rising profile V₂ in the circumferential direction, which defines a second stroke H₂. If, therefore, the actuating ring 13 is moved in rotation about the drum axis X in the direction of arrow P₂, this being accomplished by activation by way of the second actuator 25, the piston 19 and, together with the latter, the brake lining assembly 7 and the brake lining segments 9 thereof are likewise deflected in the radial direction.

The second stroke length H₂ is preferably smaller than the first stroke length H₁. The radial adjustment of the brake lining assembly 7 by way of rotary movement of the actuating ring 13 is preferably used for release clearance adjustment, i.e. to adjust the position of the brake linings as a consequence of the wear which occurs during their life.

To perform the rotary movement about the drum axis X, the actuating ring 13 preferably has a toothing system 33, e.g. cylindrical toothing, which is in mesh with the mechanism 27, which is operatively connected to the second actuator 25.

Consideration of the surface segments 32 of the displacement surface 31 shows that the first profile V₁ is of linear design in the axial direction. Consequently, each incremental axial movement of the actuating ring 13 is associated with a linearly proportional radial deflection of the brake lining assembly 7. When considered in the circumferential direction, the second profile V₂ between the first rotational position D₁ and the second rotational position D₂ it is developed in a manner proportional to the angle of rotation α. Each incremental change in the angle is likewise associated in a linearly proportional manner with a deflection of the brake lining assembly 7 in the radial direction. This finds its visual expression in a slightly convex curvature of the surface segments 32 of the displacement surface 31.

### REFERENCE SIGNS (PART OF THE DESCRIPTION)

1 drum brake
3 drum
4,6 flange
5 brake carrier
7 brake lining assembly
9 brake lining segment
11 lining carrier
13 actuating ring
15 stub
17 bearing assembly, pin
19 piston
21 friction surface
23 first actuator
25 second actuator
27 mechanism
29 compressed air supply
30 displacement surface arrangement
31 displacement surface
32 surface segment, displacement surface
33 toothing system
35 first axial end
37 second axial end
39, 41 steps
A₁ first axial position
A₂ second axial position
P₁, P₂, P₃ arrows
D₁, D₂ rotational position
H₁, H₂ stroke length
V₁ (first) profile, axial direction
V₂ (second) profile, circumferential direction
X drum axis
α rotation angle

What is claimed is:

1. A vehicle drum brake (1), comprising:
a drum (3) having an inner friction surface (21) formed circumferentially,
a brake carrier (5), which is arranged within the drum (3) in such a way that it can move in rotation relative to the drum (3) about a drum axis (X),
a brake lining assembly (7), which is arranged on the brake carrier (5), wherein the brake lining assembly (7) has a plurality of radially movable lining carriers (11), on each of which a brake lining segment (9) is provided, facing the friction surface (21),
an actuating ring (13), wherein the actuating ring (13) is displaceable along the drum axis (X) and rotatable about the drum axis (X),
wherein the actuating ring includes a displacement surface arrangement (30), which is operatively connected to the lining carriers (11),
wherein the displacement surface arrangement (30) is sized and arranged such that both axial displacement and rotary movement of the actuating ring (13) causes a respective synchronous radial movement of each of the lining carriers (11).

2. The vehicle drum brake (1) as claimed in claim 1,
wherein the actuating ring (13) is coupled to a first actuator (23) that causes the axial displacement of the actuating ring (13),
wherein the actuating ring (13) is coupled to a second actuator (25) that causes out the rotary movement of the actuating ring (13), and
wherein the first and second actuators (23, 25) are kinematically decoupled from one another.

3. The vehicle drum brake (1) as claimed in claim 1,
wherein the actuating ring (13) is axially displaceable between a first, retracted, axial position (A1) and a second, extended, axial position (A2),
wherein the axial displacement from the first axial position (A1) to the second axial position (A2) is converted in a radial direction into a first stroke length (H1) of the brake lining assembly (7), and
wherein the actuating ring (13) is rotatable between a first rotational position (D1) and a second rotational position (D2),
wherein the rotary movement from the first rotational position (D1) to the second rotational position (D2) is converted in a radial direction into a second stroke length (H2) of the brake lining assembly (7).

4. The vehicle drum brake (1) as claimed in claim 3,
wherein the first stroke length (H1) and the second stroke length (H2) differ, wherein the larger of the two stroke lengths (H1, H2) defines a range of movement for an application and release movement of a main braking function of the drum brake (1), and the smaller of the two stroke lengths (H1, H2) defines a range of movement for a release clearance adjustment of the drum brake (1).

5. The vehicle drum brake (1) as claimed in claim 4,
wherein the first stroke length (H1) is larger than the second stroke length (H2).

6. The vehicle drum brake (1) as claimed in claim 1,
wherein the displacement surface arrangement (30) has a displacement surface (31) which faces the brake lining assembly (7) and which interacts with the brake lining assembly (7) in such a way that a movement of the displacement surface (31) is converted into the radial movement of the lining carriers (11).

7. The vehicle drum brake (1) as claimed in claim 6,
wherein the displacement surface (31) has a rising profile (V1), relative to the drum axis (X), from the first axial position (A1), along the drum axis (X), in the direction of the second axial position (A2), which profile defines the first stroke length (H1).

8. The vehicle drum brake (1) as claimed in claim 7,
wherein the displacement surface (31) is divided into a plurality of surface segments (32), wherein each of the lining carriers is assigned a dedicated surface segment (32).

9. The vehicle drum brake (1) as claimed in claim 8,
wherein, the surface segments (32) of the displacement surface (31) have a rising profile (V2), relative to the drum axis (X), in the circumferential direction from the first rotational position (D1) in the direction of the second rotational position (D2), which profile defines the second stroke length (H2).

10. The vehicle drum brake (1) as claimed in 9,
wherein the profile (V1) in the axial direction between the first axial position (A1) and the second axial position (A2) is linear.

11. The vehicle drum brake (1) as claimed in 10,
wherein the profile (V2) in the circumferential direction between the first and second rotational positions (D1, D2) is proportional to the angle of rotation (a).

12. The vehicle drum brake (1) as claimed in claim 1,
wherein the first actuator (23) is a pneumatic actuator.

13. The vehicle drum brake (1) as claimed in claim 12,
wherein the second actuator (25) is an electric motor actuator.

14. The vehicle drum brake (1) as claimed in claim 13,
wherein the second actuator (25) is coupled to the actuating ring (13) by way of a mechanism (27).

15. The vehicle drum brake (1) as claimed in claim 14, wherein the actuating ring includes a plurality of gear teeth, and the mechanism (27) is a gear mechanism, wherein the gear mechanism (27) is coupled to the plurality of gear teeth.

16. The vehicle drum brake (1) as claimed in claim 6,
wherein the displacement surface (31) is divided into a plurality of surface segments (32), wherein each of the lining carriers is assigned a dedicated surface segment (32).

17. The vehicle drum brake (1) as claimed in claim 16, wherein the surface segments (32) have a convex profile.

18. The vehicle drum brake (1) as claimed in claim 17, wherein each of the surface segments (32) has a rising profile (V1), relative to the drum axis (X), from the first axial position (A1), along the drum axis (X), in the direction of the second axial position (A2), which profile defines the first stroke length (H1).

19. The vehicle drum brake (1) as claimed in claim 18,
wherein, each of the surface segments (32) have a rising profile (V2), relative to the drum axis (X), in the circumferential direction from the first rotational position (D1) in the direction of the second rotational position (D2), which profile defines the second stroke length (H2).

20. The vehicle drum brake as claimed in claim 1,
wherein the displacement surface (31) is segmented such that, for a given rotary position of the actuating ring (13) about the axis (X), an axial displacement of the actuating ring (13) in the direction of the axis (X) causes the same radial displacement of each of the lining carriers (11),
wherein the rotary position of the actuating ring (13) is adjustable to account for wear to the brake linings over time,
wherein axial movement of the ring (13) translates the lining carriers toward the friction surface during a braking operation;
wherein a first actuator effects the axial movement;
wherein a second actuation, independent of the first actuator, effects the rotary movement, such that the rotary movement and the axial movement may separately and independently effected.
